(19) United States
(12) Patent Application Publication
(10) Pub. No.: US 2025/0029147 A1
(43) Pub. Date: Jan. 23, 2025

(54) ADVERTISING METHOD AND TOOL

(71) Applicants: Multi Mobile Media LLC, Trooper, PA (US); A3 Mediaco, LLC, Trooper, PA (US)

(72) Inventor: Frank R. Gussoni, Trooper, PA (US)

(21) Appl. No.: 18/773,848

(22) Filed: Jul. 16, 2024

Related U.S. Application Data
(60) Provisional application No. 63/527,362, filed on Jul. 18, 2023.

(51) Int. Cl. G06Q 30/0251; G06Q 30/0241; G06Q 30/0273

(52) U.S. Cl. CPC G06Q 30/0267; G06Q 30/0255; G06Q 30/0273; G06Q 30/0276

(57) ABSTRACT

An advertising method is provided. The method includes electronically receiving a request from an electronic device of a consumer for advertisement content concerning a particular brand or product, and in response to the request, electronically providing access to the advertisement content concerning the brand or product. The request received from the electronic device of the consumer may include information provided by an image of a product of interest. The advertisement content to which access is provided may be determined based on use of image recognition software matching the information provided by the image of the product of interest to a catalogue of product information stored in a database. An app having a reader is also disclosed.

### CROSS REFERENCE TO RELATED APPLICATIONS

This application claims the benefit under 35 USC § 119 (e) of U.S. Provisional Patent Application No. 63/527,362 filed Jul. 18, 2023.

### BACKGROUND

The present invention relates to methods and tools used to advertise products, services, and brands to consumers and to methods and tools for consumers to readily access information concerning a product, service, or brand to assist in buying decisions and the like.

Advertising is a marketing communication that generally employs an openly sponsored, non-personal message to promote or sell a product, service or idea. Sponsors of advertising are typically businesses wishing to promote their brands, products, or services. Commercial advertisements often seek to generate increased consumption of their products or services through branding which associates a product name or image with certain qualities in the minds of consumers.

Typically, advertisements are non-personal in that they are not directed to a particular individual. Advertising may be communicated through various mass media, including, for instance, traditional media such as newspapers, magazines, television, radio, outdoor advertising or direct mail, and other media such as search results, blogs, social media, websites or text messages. The actual presentation of the message in a medium is referred to as an advertisement (advert or ad for short).

Typically, an advertiser pays for and has control over the message conveyed by an advertisement; however, advertisements are generally widely broadcast to a large population of consumers without any guarantee that a particular desired or interested consumer will receive and/or view the advertisement or has any interest or need in viewing the advertisement at the time of presentation.

### SUMMARY

According to an embodiment, an advertising method is provided. The method includes the steps of electronically receiving a request from an electronic device of a consumer for advertisement content concerning a particular brand or product, and in response to the request, electronically providing access to advertisement content to the consumer concerning the brand or product. The request received from the electronic device of the consumer may include information provided by an image of a product of interest. In response to the request, the advertisement content to which access is provided may be determined based on use of image recognition software matching the information provided by the image of the product of interest to a catalogue of product information stored in a database.

According to another embodiment, a mobile app for an electronic mobile device is configured to cause advertisement content associated with a product scanned by a reader of the app to be displayed on the electronic mobile device.

### BRIEF DESCRIPTION OF THE DRAWINGS

FIG. 1 is a flowchart of an in-store advertising process in accordance with an embodiment.

FIG. 2 is a flowchart of an e-commerce advertising process in accordance with an embodiment.

FIGS. 3A-3C provide a flowchart of a process for setting up an advertisement campaign in accordance with an embodiment.

FIGS. 4A-4C provide a flowchart showing the operation of an advertisement campaign in accordance with an embodiment.

FIG. 5A-5B is a flowchart of interactions occurring between a campaign administer, a brand owner, and a retailer in accordance with an embodiment.

### DETAILED DESCRIPTION

According to an embodiment, an advertising method and tool are provided in which sellers of goods deliver custom advertisements or like content at a point of purchase to a consumer via a process that may be fully initiated by the consumer. Accordingly, such a process can be made more affordable for the seller since the ad is not necessarily widely broadcast and is more targeted and delivered only to interested consumers, can provide accurate and timely information to a consumer that is highly interested in receiving such content at the time of delivery/presentation and thereby eliminates media waste (i.e., media widely broadcast to the public at large at random times rather than to a select few that are interested in the media at a particular point in time when interest is greatest).

According to an embodiment, the process may be entirely or at least substantially user (i.e., consumer) engaged and initiated. Thus, the advertisement or informative content is actually desired by the consumer at the time of delivery and is being requested by the consumer. This eliminates advertisement fraud and provides the seller with an opportunity to make a connection with a consumer that wants to know and learn more about a brand before purchasing goods while at a point of purchase.

The advertising or like content that may be delivered during the above referenced process may highlight a brand's unique and differentiating qualities and inform and educate consumers at the point of purchase. For instance, the content may provide health benefits of ingredients or the like, may educate on how to incorporate the goods of the brand into a meal or the like, may offer menu suggestions that pair well with the goods of the brand, may offer shoppers an incentive to sample a brand, or may provide any other information deemed useful for a consumer making a buying decision at a point of purchase (i.e., in-store or on-line).

For the seller of the goods under a brand, the process provides an efficient and affordable advertising alternative (i.e., restricted to a specified number of views of ad content per month). The content may be carefully controlled such that advertising budgets may be set and not exceeded. The content may be designed to keep the messaging genuine and creative costs low. For example, the content may consist of short videos obtained via use of a smart phone or the like. Further, since the process is consumer engaged, there is no ad fraud, and frequent creative changes may be made to the content to keep the message fresh. There is no ad clutter, and the brand and message appear immediately to an interested consumer. The process ensures accurate accounting on consumer engagement, guarantees that an advertiser pays only for the information delivered, and provides an environmentally friendly approach to advertising.

According to embodiments, the advertising method may be used in an in-store point of purchase process or may be used during an on-line e-commerce purchase. According to at least some embodiments, ad content is uploaded to a server or cloud which can be accessed by consumers via an app or other software loaded on a smartphone or like mobile device or via use of a computer.

### In-Store Point of Purchase Process

With respect to in-store advertisements, a customizable mobile application or app portal may be used that allows consumers to engage with a brand on a personal level at the moment of a buying decision. The mobile application or app may be in the form of a computer program or software application designed to run on a mobile device such as a smartphone, tablet, watch, or the like. The app may provide the consumer access to useful information, for instance, while shopping in the aisle of a store or the like.

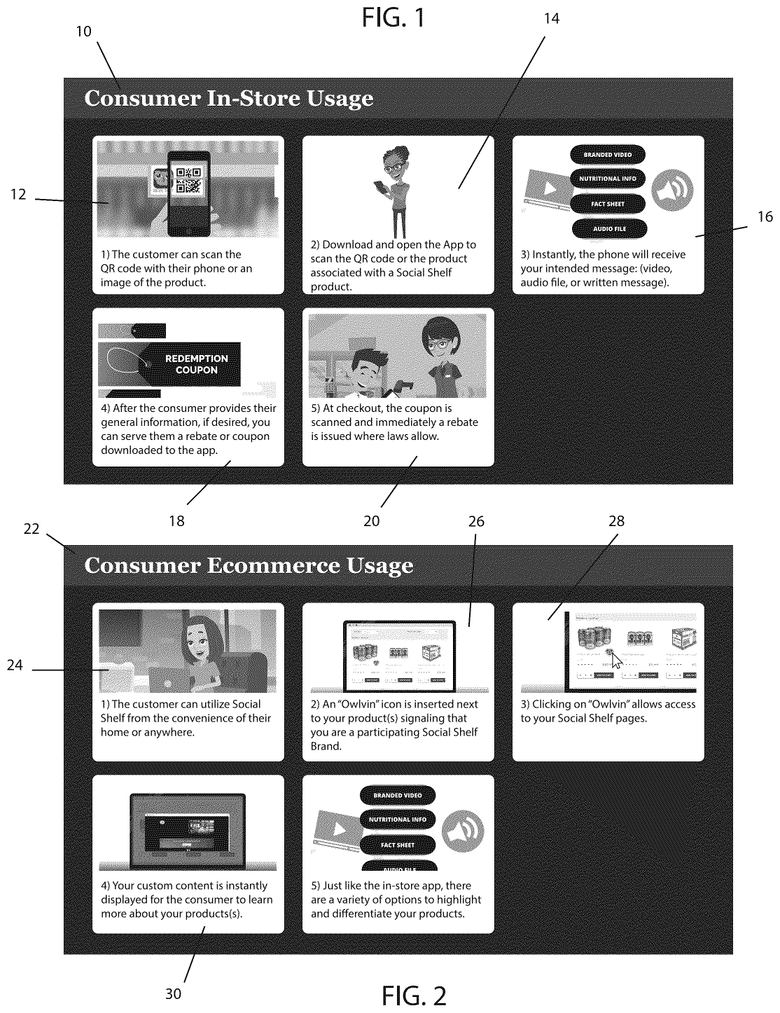

By way of example of an in-store embodiment 10 as shown in FIG. 1, a consumer may initially download an app on their smartphone or like mobile device and may open and use the app in a brick-and-mortar retail store, such as a grocery store or liquor store, to scan a machine-readable optical label, such as a QR code, barcode, or the like. See steps 12 and 14. According to an alternate embodiment, the consumer may use the app on their mobile device to capture an image of the product itself, instead of an associated code.

In response to the consumer scanning the QR code or the like or capturing an image of the actual product, the advertisement content stored for the particular product is immediately transmitted from a server or the like to the linked consumer's smartphone and displayed to the consumer. See step 16. The content may be in the form of one or more videos, images, audio files, text messages, product information, fact sheet, or the like. According to some embodiments, the consumer may be requested for some general information and may be provided with a rebate or coupon that is downloaded by the app on the consumer's smartphone. See step 18. The consumer may then proceed to buy the goods and use the coupon or the like at checkout. See step 20.

Accordingly, in the above-described process, the scanning of a QR code or like machine-readable optical label or capturing an image of the product itself may provide a consumer with valuable product information at the moment a consumer is considering a purchase at the point of purchase. Thus, the above-described advertising process and tool permits the owner of a brand of products the opportunity to engage and influence a consumer's purchasing decision at the most critical point of the buying cycle—i.e., when the consumer is in the aisle of a store (or online as discussed below). The method permits brands the ability to grow and remain viable, without large advertising budgets for the preparation and dissemination of the ads.

For the first embodiment referenced above, a tag or the like placed on or adjacent the goods may identify participating brands. The tags may be as small as 1 inch by 2 inch or the like and may be provided in the form of a standalone tag or a shelf tag extension. Each tag can include an identifying logo or the like for the advertising system or platform and/or may include a unique QR code or the like that instantly links and causes the advertisement message to be displayed to the consumer (for instance, via web display). Thus, the QR code or the like may be linked to a unique URL (i.e., web address) that communicates to and/or opens the ad content on the consumer's smartphone or the like.

With respect to the alternate embodiment referenced above, the image scan of the actual product may be used to determine the product or brand of interest (without relying on an associated tag, QR code, or the like). Here, the scanned image and/or information obtained from the image may be compared to stored images and/or information to determine the product of interest. This may be based on automated recognition of product shape, information provided on the label or packaging, and/or text or text font appearing on the product or packaging. For instance, artificial intelligence label and text recognition may be utilized that receives the scanned image of the actual product of interest and determines the product of interest from recognizing features thereof from a stored database of images of numerous products. This may be performed by an app or by a cloud or remote server one which image recognition software operates. For purposes of this disclosure, a remote server and a cloud server are synonymous and both refer to a server not located at the point of purchase.

The above method may include training a machine-learning algorithm to recognize features of products within the catalogue of product images stored within a database. The trained machine-learning algorithm can then be used in the process to identify the product of interest of the consumer.

Software, such as software using artificial intelligence technology, may be used with apps, such as Android and IOS apps. Product image scans obtained via the apps may be used for finding campaign details for products and the like. A product manufacturer or seller may upload multiple product images and font and text metadata information into a product database. When an end-user scans a product, the algorithm of the artificial intelligence software prioritizes matching the image with the campaign by the highest percentage match. If multiple campaigns have similar match percentages, the most recently created active campaign can be selected. If a photo or the like has not been uploaded for the scanned product, then the consumer may be directed to scan an associated QR code or the like with the Web Application.

By way of example and not by way of limitation, the process may use Google Cloud Vision AI (v1.6.5) software or the like to obtain image metadata and match. The software may be contained and run within the app or within the cloud or remote server. For this purpose, a database including a product catalogue must be created for each participating brand. For instance, the catalogue may include images taken from the front, back, sides and top of each participating product. Alternatively, the catalogue may contain information concerning text and font information concerning text appearing on packaging or labels of the produce. Without this library of images and text font, Google's Cloud Vision AI software will be unresponsive. A tri-lateral custom cloud server will communicate with Google's Cloud Vision AI software coding language and the coding language of the app.

Accordingly, a process may include a consumer opening an app downloaded on their mobile device. The app may include a reader, such as a reader using artificial intelligence technology (AI reader), which may substantially instantaneously or with minimum delay communicate the product image taken by the consumer's mobile device or text or other information concerning the product, which will necessarily include the likeness of the product and/or packaging and verbiage appearing thereon, to the remote or cloud server. Once the connection has been made through the app on the consumer's mobile device to the cloud server, the cloud server will sort through the entire catalogue library and determine the appropriate product, brand, etc., using a machine-learning algorithm, label and text recognition, or the like. Product shape, colors, etc. may also be utilized and considered. Once the product/brand of interest is determined, such data is linked and/or transferred to a product page remote server. Thereafter, the consumer will receive the appropriate product messages, ads, videos and/or imagery from the product page server. After this action has been completed, the app on the consumer's mobile device will close out of that page but remain on, until such time as the consumer closes the app.

As described above, the process combines and uses three different technologies (i.e., the consumer's mobile device loaded with app, the AI software, and the cloud server). For instance, the process can require tri-lateral language of the app (downloaded on the consumer's mobile device) to bridge communications between Google's Cloud Vision AI Technology software or the like, the tri-lateral cloud service (AWS server or the like), and the consumer's mobile device. In at least some contemplated embodiments, no other mobile camera or QR reader will be recognized by this system and will be allowed to penetrate the system. Thus, the process can be embodied in a closed and locked system.

The content provided to the consumer (whether obtained via a scanned QR code or scanned image of the product) may be product information that may enable a consumer to make a more informed and proper buying decision, may eliminate wasteful spending on relatively large-scale advertisements, and may enable consumers to become more educated shoppers. The content may include a short video, an audio message, an information sheet, a fact sheet, a suggested recipe or food pairing, a coupon, or any other information or detail that may assist a consumer to make an informed buying decision. In addition, consumers that use the app may register for information concerning a particular brand and may then receive additional messaging from the brand via the app. Thus, the process is entirely or at least substantially consumer initiated thereby ensuring that the advertisement content is only provided to and viewed by consumers particularly interested in such content thereby providing an efficient process in which ad costs can be controlled and maintained at a relatively low level.

According to some embodiments, consumers that register with a brand may automatically receive push notifications (i.e., hereinafter referred to as Premier Ads) to their smartphones or the like for purposes of providing brand priority opportunities. As one example, a GPS enabled device of a registered consumer may indicate when the consumer is in close proximation to a participating location or retail site (i.e., within the parking lot of a store, adjacent the front entrance of the store, within the store, or the like). When such close proximity is detected, the consumer may automatically receive brand notifications to their device which may include special pricing or deals, coupons, or other information intended for the particular consumer.

The app may also provide a store finder function to assist consumers in locating participating retailers, for instance, within a specified radius of the consumers current location (i.e., within a 10-mile radius or the like). The app may also provide directions to the store from the user's current location.

In addition, the app may provide gamification. For instance, a particular brand may provide a “game of skill” or “random chance to win” game to the app to engage the consumer and attract attention to the brand. For instance, the gamification may be customized to match a promotional program of the brand owner or seller and may provide random or preset winning limits. Such contests may be individual consumer contests, multi-market contests, or national contests. Upon winning a game, completing a game, or winning a random chance, the consumer may receive a coupon or other prize of a particular value.

Still further, the app may provide the consumer with a direct interface with the retailer (i.e., consumer to store staff interface). For instance, customers may use the app to page retailer staff, communicate with a service counter, or be directed to product location within the retail store.

By way of example, while a consumer is shopping in a participating retailer's aisle, any participating product, whether using the QR code technology or product library, can permit a communication portal to the Social Shelf pages. Then, if a consumer wants a product that may be out of stock, or if they want to purchase a product locked behind glass or a cage, the consumer uses a call button on the app and their cell phone will immediately be connected to a SMS and/or email delivery service that will immediately be sent to the designated store staffer or store support counter, depending on the retailer's preference, along with exactly which product needs assistance. As soon as the message is delivered to the retailer, the system then generates a second reply message back to the consumer with a custom message, explaining a staff member will either meet them in the aisle with the out of stock product or to unlock the cabinet restraint. If the product is kept in another location, the consumer will be directed to exactly where they should proceed to obtain and purchase the product.

If the consumer does not have the app on their phone, the message may be more generic and will not reply using to their name. However, if the consumer uses the app, the reply message may say, for instance: “John, an associate will be with you momentarily to assist you with your Cognac purchase. Thank you.” Or the message may read: “John, please proceed to the service counter and your Hedge Trimmer will be ready for purchase. Thank you.”

### Ecommerce Process

According to an e-commerce or on-line embodiment 22 as shown in FIG. 2, products offered for sale at on-line websites may be highlighted by and include a unique icon or the like that corresponds to the advertising process. When an on-line consumer clicks on the icon, the on-line consumer can be provided with the same content and functionality as discussed above with respect to the in-store embodiment without leaving the retail website. For instance, as shown in FIG. 2, an on-line consumer may see the icon (i.e., in this case, an image of an owl) appearing next to a product. See steps 24 and 26. The consumer may click on the icon to access the advertisement content. See step 28. The content is then immediately displayed to the on-line shopper so that the shopper may learn more information about the product. See step 30.

Accordingly, as discussed above, embodiments disclosed herein (in-store and ecommerce) provide an advertising tool and/or platform that allows an owner or seller of a brand of products or services an opportunity to advertise to consumers at retail and ecommerce sites, when the consumers are right in front of the products and are considering a purchase. The tool can be 100% consumer initiated by scanning a QR code, barcode, or the like, by scanning an image of an actual product with via use of the app, or by clicking on a special icon which is linked to a unique URL (i.e., web address). This causes an advertisement for the brand to be immediately downloaded to the consumer's smartphone, mobile device, computer, or the like.

### Example—Advertising Campaign Set Up and Distribution

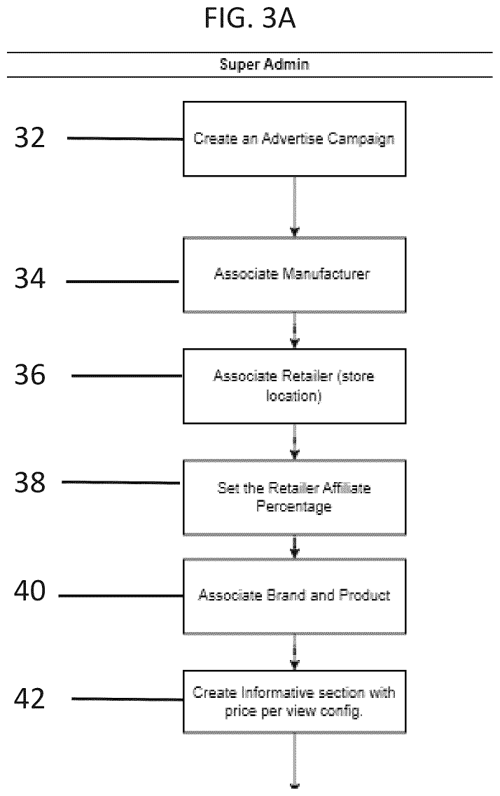

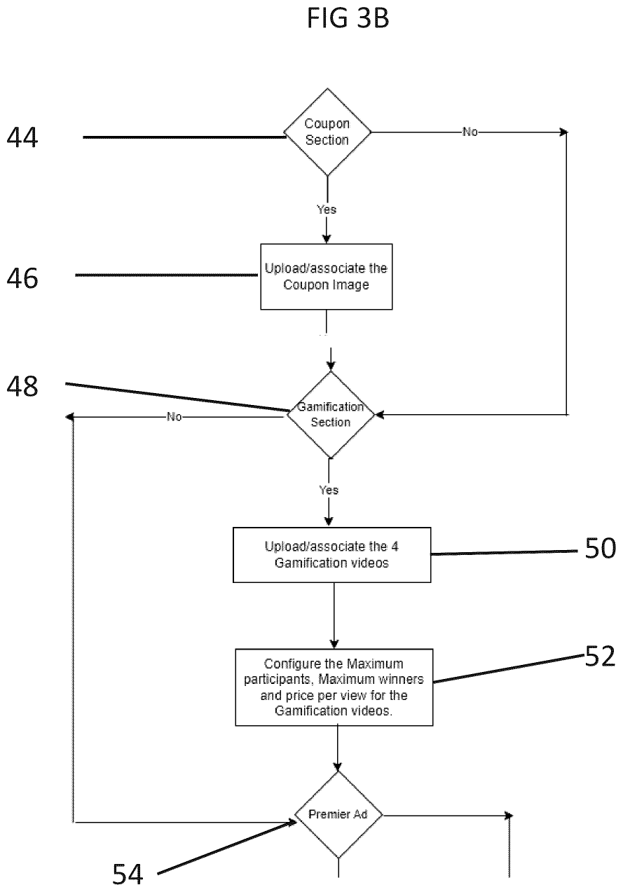

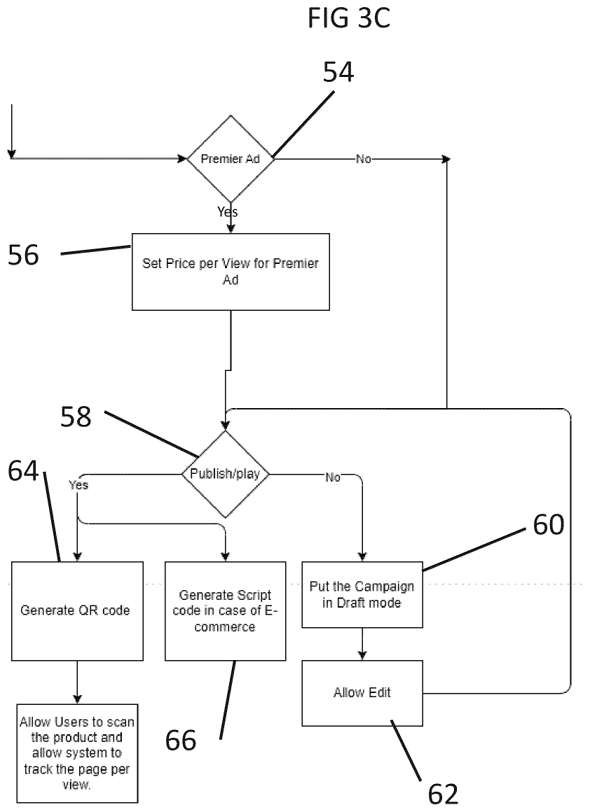

FIGS. 3A-3C show the steps of a process for setting up the advertising campaign discussed above. Referring to FIG. 3A, a so-called “Super Admin” (i.e., the administrator of the process, platform, or app) assists in creating an advertisement campaign in step 32. The campaign is associated with a manufacturer (or brand owner or source of the goods) in step 34 and a retailer (store location or website) in step 36. The retailer affiliate percentage is set in step 38 and a particular brand and one or more products are associated in step 40. Thereafter, informative content is created for each product or brand and is associated with a price per view in step 42.

In addition, step 40 may include the use of a tab in a campaign create/edit screen which may be provided for uploading multiple product images/photographs and other metadata (such as font, text, etc., appearing on packaging or labels on packaging) into the Admin Panel. The images will be added to the product catalogue database on the cloud server accessible by the software used to match an image of a product taken by a consumer to a product in the product catalogue. If the admin does not upload any photographs of the product, the advertising campaign will be automatically excluded from the list of products that can be scanned by end-users. Thus, the advertising campaign will be limited to use of a QR code or the like.

Referring to FIG. 3B, the optional use of a coupon is then considered in step 44. If a coupon is being used with the campaign, then an image of the coupon is uploaded and associated with a product in step 46. Thereafter, the optional use of gamification is considered in step 48. If gamification is being used with the campaign, then one or more gamification videos are uploaded and associated with a product in step 50. Further, the maximum number of participants and maximum number of winners are set in step 52 and a price per view for the gamification videos is set. Thereafter, the optional use of a so-called “Premier Ad” is considered in step 54 (i.e., the automatic push notifications as discussed above). If a Premier Ad (i.e., push notification) is being used with the campaign, then a price per view for the Premier Ad is set in step 56.

Referring to FIG. 3C, after the above steps have been accomplished, the advertisement campaign is ready to be published/played in step 58. If the campaign is still in a “draft mode” as shown in step 60, further edits can be made in step 62 before being available to consumers. If the campaign is ready to be made available to consumers, a QR code or the like is generated in step 64 for in-store use and/or a script code is generated in step 66 for e-commerce use. Should the QR code be scanned by a particular consumer, the content is immediately transmitted to the consumer and the system tracks and stores the page per view.

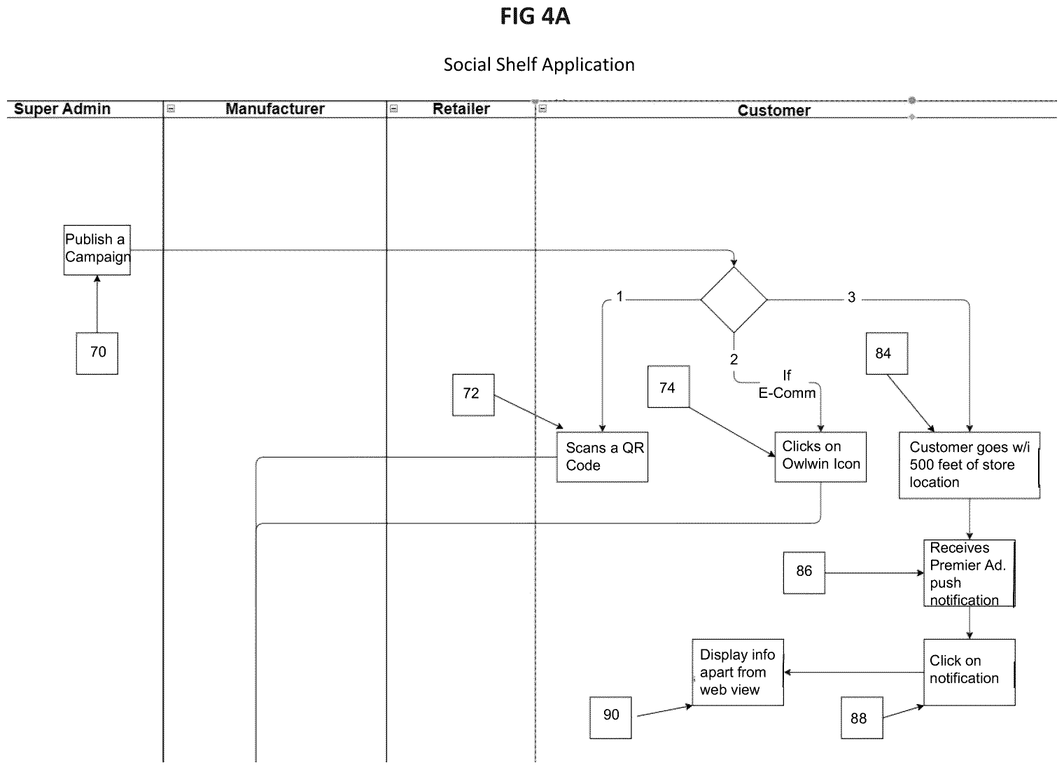

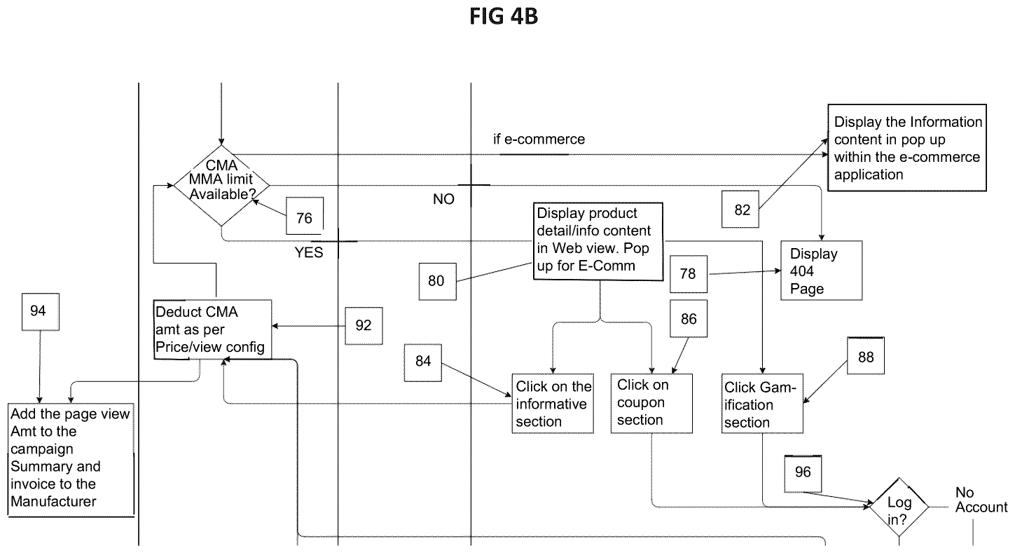

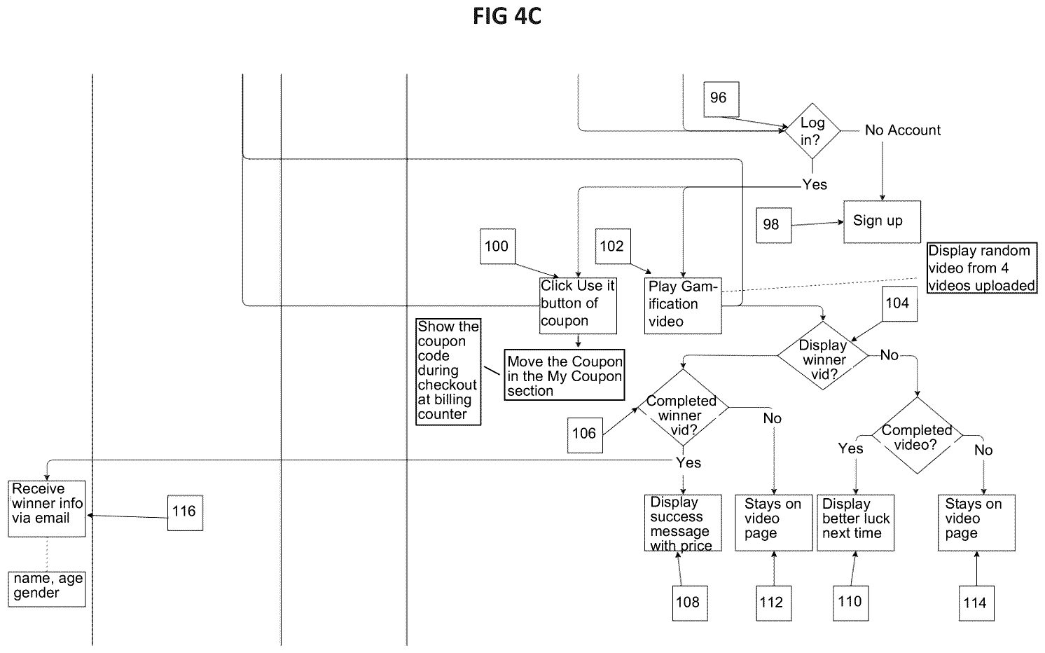

FIGS. 4A-4C show the steps of a process for publishing and distributing the advertising campaign discussed above. Different steps are taken by each of the Super Admin of the advertising campaign, the manufacturer or brand owner of the product, the retailer or store owner where the product is sold, and the consumer. The advertising campaign is published by the Super Admin in step 70 as discussed above. At this point in the process, nothing further occurs until action is initiated by a consumer at a point of purchase.

A consumer may scan the QR code or the like at an in-store location in step 72 or may click on an icon on a retail on-line e-commerce website in step 74. In the alternative, the consumer may capture an image of the product or product packaging of interest and rely on product recognition technology as discussed above. The system then checks if any limits have been met in step 76 (for instance, if the maximum number of pages have been viewed for a particular billing cycle, etc.). If a limit has been reached, a max limit page is displayed to the consumer in step 78. Otherwise, the advertisement content is displayed in web view to the consumer in step 80 or provided as a pop-up within an e-commerce website being viewed by the consumer in step 82. In addition, in connection with a Premier Ad (push notification) if the customers are within 500 feet or other pre-set distance from a geofenced store in which the campaign is active (see step 84), then a push notification Premier Ad concerning a particular product/brand registered by the consumer is transmitted to the consumer's smartphone or the like in step 86. If the consumer selects the notification in step 88, then the content is downloaded or linked to and displayed on the consumer's mobile device in step 90.

Referring to FIGS. 4A and 4B, the consumer may select the informative content in step 84, the coupon section in step 86, or the gamification section in step 88. If the informative content is selected by the consumer, then the limits set by the manufacturer or brand owner are updated in step 92 and information concerning the campaign usage summary page and invoice to the manufacturer is updated in step 94.

Referring to FIGS. 4B and 4C, if a coupon or gamification is selected by the consumer, the consumer must log into an account in step 96 (or create an account in step 98), to obtain the coupon in step 100 or to play the gamification video in step 102 (for instance, display a random video form four uploaded videos with only one being a winner). If a winner video is displayed in step 104 and is completed in step 106, then a winner display screen is displayed in step 108. Alternatively, a “better luck next time” display is displayed in step 110 or the video continues in play mode if the entire view has not yet been played/viewed in steps 112 and 114. If a coupon is selected, then the limits are updated in step 92 and the campaign usage summary page and invoice to manufacturer are updated in step 94. If the gamification is played and won by the consumer, then winner information (name, address, age, and gender) is collected in step 116 for prize fulfillment.

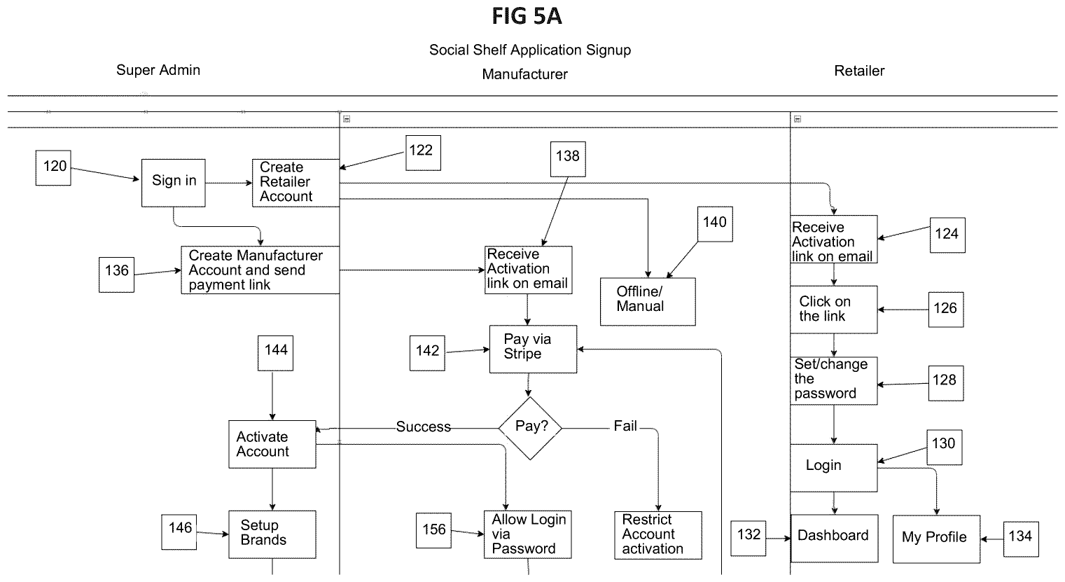

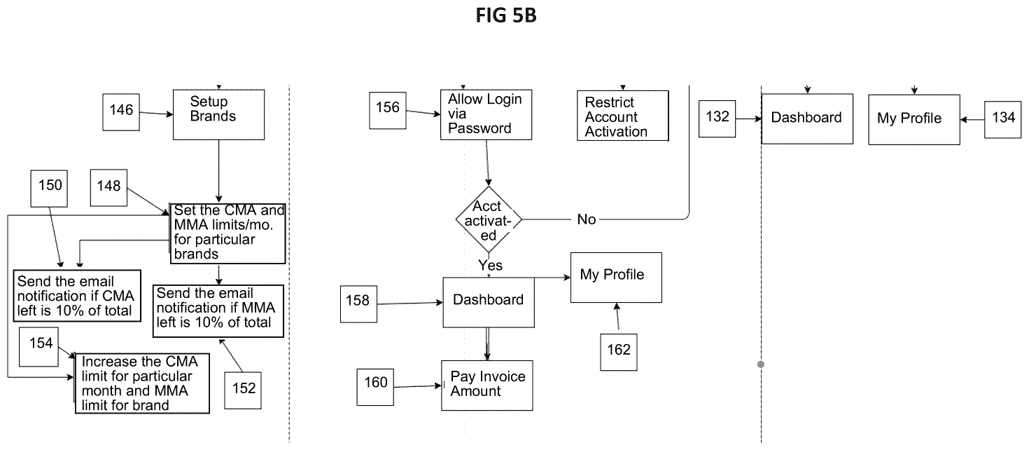

FIGS. 5A and 5B show interactions between the Super Admin, the manufacture or brand owner, and the retailer in accordance with an embodiment. The Super Admin signs into the system in step 120 and may create a retailer account in step 122. The retailer receives an activation link from the Super Admin in step 124, selects the link in step 126, sets or changes a password in step 128, and then logs into the system in step 130. The retailer can then access a dashboard in step 132 (to see usage of the campaign) or may access a profile page to update profile information in step 134.

The Super Admin may create a manufacturer (brand owner) account and send a payment link in step 136. The brand owner receives a password and payment link in step 138, can access an offline manual in step 140, and pay the invoice on-line in step 142. If payment is submitted, then the Super Admin will activate the account in step 144, set up the brands in step 146, and set monthly limits relative to the campaign usage in step 148. If within 10% of the total limit, emails are sent to the brand owner in steps 150 and 152. The limits can also be changed in step 154. When the Super Admin activates the account, the brand owner is able to log in to the system in step 156 and can thereafter gain access to a dashboard, a page for submitting payment to an invoice, and a profile page in steps 158, 160 and 162.

Accordingly, from the viewpoint of a consumer, the mobile app may be freely accessed and downloaded from an app store. The app may be opened and used to scan a QR code or the like or capture an image of the product or packaging of the product and a brand ad will be displayed to the consumer on the consumer's smartphone or like mobile device. Thus, upon scanning a QR code or an image of the product, one or more pages of content will open up on the smartphone which may contain informative content pages, a coupon page, and/or a gamification page for a particular brand depending upon which QR code is scanned. By default, the first page of informative content may be displayed which contains links to view other pages which might be other informative content pages or coupons or gamification pages depending on the ad contents which may be managed via an Admin Panel by the Super Admin or other users. The informative content of the ad may be provided via audio message(s), video(s), image(s), text content, and the like. If desired, multiple pages of informative content may be displayed.

Coupon related content of the ad may be provided as an image or the like. This content is accessible to login users that have set up an account on the app. If the user does not have an account, then they can be directed to register for an account. To redeem the coupon, a customer is required to present the coupon at the time of checkout at the billing counter reception. The receptionist at the billing counter will scan the coupon and a rebate is issued immediately.

Gamification content of the ad may be provided in the form of videos or the like. This content is made accessible to login users. Based on the configuration of the gamification content on the Admin Panel, random video from the gamification videos uploaded on the admin panel for respective brands may be displayed. For instance, one or more videos among all the uploaded gamification videos may be marked as a winning video by the Super Admin (for instance, one winner out of four total videos). If the video is played by a customer when participating in gamification, then, respective customer information will be submitted to the platform and the platform will forward winner details to the brand manufacturer for process fulfillment.

Store finder content provided on the app may include a Map View. This page displays nearby retailer store locations with distance from the user's current location on the map view. The app may display a route to reach the respective retailer store location.

The app may permit a consumer to report a problem by submitting a form. Consumers will fill in details such as problem title, description, brand, product, retailer name, and store location or ecommerce site name, checkboxes with pre-defined options (like internet issue or Wi-Fi issue, no page displayed etc.), and the like.

When a consumer initially downloads the app, the app will include a number of walkthrough screens providing the consumer with information on how to use the app. In addition, authentication may be required such as providing a username or email address, user password, and reCAPTCHA (i.e., to distinguish between human and automated access to the website). New passwords can be set via password link such as when passwords are forgotten or the like. A consumer may also register for an account by providing an email address, password, confirm password, mobile telephone number, gender, age group, and the like. Users must accept the terms & condition and privacy policy of the platform. An account activation link may be sent to the user's email upon successful registration.

The user/consumer may set and manage their profile for the app. For instance, a user may manage profile information including email, password, mobile telephone number, gender, age group, and may change or update any of this information. In addition, the user may be provided with a list of coupons which the user has received for easy access. Such coupons may be set to be removed from the list, for instance, after a 2-hour time period from scanning a QR code which provided the coupon.

The app may be used to receive or send email notifications to the manufacturer, end customer, retailer, administrator, or the like. These notifications may include account creation, verification, forgot password, email change, coupon code redeem, video gamification winner, or the like.

The app may also be responsible for receiving or managing push notifications sent to the customer concerning products using geo targeting techniques when within a pre-selected certain distance (i.e., 500 feet or the like) from a particular participating retailer.

E-commerce use by a consumer is similar to as described above for the mobile app. However, in the ecommerce arrangement, icons are clicked instead of QR code or product image scanning.

From the standpoint of an administer, such as the Super Admin or other admin, the advertising system or tool may be managed via an admin panel on a web display. The Admin may be authenticated with username/password combination. The admin will then gain access to the admin panel which includes a dashboard. The dashboard may display statistics, page view graphs for all campaigns, filters for page view graphs, customer lists, and page view histories.

By way of example, the statistics for a particular month, such as the current month, may include total number of Active Campaigns, Total Invoice Amount to be received, and total Billing Amount to be paid to retailers. The page view graphs may include bar or line graphs depicting the page view day wise based on selected filters. By default, the graph may display the day wise page views for the current month. Filters can be applied to the graphs, for instance, to filter the page view graph by specific month, past 30 days, a custom date range, by specific time range (i.e., 9:00 AM to 2:00 PM), by manufacturer (or brand owner), by campaign, by brands, by products, by retailers and store location, and/or by customers. A customer list of all customers that scanned a QR code or clicked on an icon during a selected period of time can be generated. In addition, a history of page views can be downloaded in desired format (i.e., spreadsheet) and filtered as described above.

The admin will also be able to manage customer users, manufacturer (or brand owner) users, retailer users, and sub-admin users. For instance, an admin may be able to list, add, view, edit, delete, activate or deactivate customer users, manufacturer users, retail users, and sub-admins. For manufacturers, the admin may be able to manage information concerning contact information, subscription package, brands, and brand wise monthly restrictions (i.e., MMA and CMA). If the restrictions are reached, then the ad campaign for the respective brand of the manufacturer will become unavailable to consumers via the app. The admin will also have oversight as to monthly subscription fees billed and collected and will be able to increase or decrease monthly restrictions. For retailers, the admin may be able to manage information concerning store name, street address, email address, phone number, bank account information and the like. For sub-admins, the admin may be able to manage roles and permissions.

The admin will also be able to manage brands and products and may be able to list, add, view, edit, delete, activate or deactivate brands, products, product names, product descriptions, and ad campaigns. The admin may also be able to manage ad campaigns. For instance, the admin may be able to search campaign and filter by manufacturer, retailer, retail store location, brank, product, date range, and the like. The admin may be able to view page view graphs of ad campaigns and premier ads and historical data thereof. The admin may be able to associate manufacturers with ad campaigns, retailers with ad campaigns, and affiliation percentages for retailers.

The admin may also be able to manage ad campaign content including content name for each section of the content (i.e., audios, videos, images, and text) and price per view. The admin may also be able to manage coupon content including coupon image and price per view and gamification including price per view, uploading videos, tagging winning video, and determining maximum number of participants and winners. The admin also manages premier ads (i.e., push notifications) and price per view. The admin also can track campaign progress statistics including total page view total cost, page view of current month, and ad cost for current month. This is true also for premier ads. The admin may also manage the generation of QR codes and script codes and manufacturer invoices, retailer bills, and reporting.

From the standpoint of manufacturers (brand owners), some similar functions described above for admins are also provided for manufactures, i.e., authentication, dashboard, statistics, graphs, filters, and invoice information.

From the standpoint of retailers, some similar functions described above for admins are also provided for retailers, i.e., authentication, dashboard, statistics, graphs, filters, and billing information.

### Example—Consumer Rewards Program

According to one contemplated embodiment, a consumer rewards program may be offered in connection with advertising campaigns.

By way of example, registered app users will accumulate one (1) loyalty point for each participating product page viewed, up to a maximum of two (2) points for each page viewed for any single product in any single month. At the end of each calendar month and at the end of each calendar year, registered users of the app with the top ten (10) highest number of accumulated page views for the appropriate period will be rewarded via electronic prizes. Prizes will be provided to the registered user's email address provided during app set-up. If this is not possible, prizes may be awarded via postal mail service. Ties may be determined based on the consumer that accumulated their point total the earliest in the respective month, or year. Users are required to be logged into the app to accumulate loyalty points.

For purposes of example only, a monthly prizes may be: 1st place $1,000; 2nd-5th place $250; and 6th-10th place $100. Yearly prizes may be: 1st place $2,500; 2nd place $2,000; 3rd place $1,500; 4th place $1,000; 5th place $500; and 6th-10th place $250. It may be possible for any individual to win more than one month, and it may also be possible for a yearly winner to never be a monthly winner, only a cumulative winner from total views generated for the full calendar year. Thus, there may be multiple ways to win.

While specific implementation details are discussed above, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Similarly, where operations are depicted in the drawings in a particular order, this should not be understood as requiring that such operations be performed in the particular order shown or in sequential order unless otherwise noted, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or platform or packaged into multiple software products or apps.

While some of the operations in the preceding embodiments were implemented in hardware or software, in general the operations in the preceding embodiments can be implemented in a wide variety of configurations, platforms, and architectures. Therefore, some or all of the operations in the preceding embodiments may be performed in hardware, in software, or both. For example, at least some of the operations in the disclosed technique may be implemented using program instructions, operating system (such as a driver for interface circuit) or in firmware.

The foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure.

We claim:

1. A method for delivering custom advertisement content to a consumer at a store, comprising the steps of:
electronically receiving a request from an electronic device of a consumer for advertisement content concerning a particular brand or product via a mobile app; and
in response to said request, electronically providing the advertisement content to the consumer concerning the brand or product;
wherein the request received from the electronic device of the consumer includes information provided by an image of a product of interest; and
wherein, in response to said request, the advertisement content to which access is provided is determined based on use of image recognition software matching the information provided by the image of the product of interest to a catalogue of product information stored in a database.

2. The method according to claim 1, further comprising the step of making a mobile app available for download to electronic mobile devices of consumers, wherein the image of the product of interest is taken at a point of purchase of the product via use of the mobile app.

3. The method according to claim 2, wherein the mobile app includes a reader or artificial intelligence (AI) reader.

4. The method according to claim 3, wherein said receiving step is accomplished in response to the reader or AI reader communicating at least one of the image of the product of interest, a likeness of the product of interest, and verbiage appearing in the image of the product of interest.

5. The method according to claim 2, wherein the information of the image of the product of interest includes at least one of the image of the product of interest, a likeness of the product of interest, and verbiage appearing in the image of the product of interest, wherein said receiving step includes receiving the information of the image of the product of interest with a cloud server having access to the catalogue, and wherein the cloud server has software configured to match the information of the image of the product of interest received from the app to a product in the catalogue.

6. The method according to claim 5, wherein the software of the cloud server matches the information of the image of the product of interest received from the mobile app to a product in the catalogue using information of at least one of product packaging, a label, and text appearing in the image of the product of interest.

7. The method according to claim 6, further comprising the step of training a machine-learning algorithm to match products of interest to products contained in the catalogue using information of at least one of product packaging, a label, and text appearing in the images of the products.

8. The method according to claim 7, further comprising the step of using the machine-learning algorithm to identify the product of interest from the catalogue using the information of the image of the product of interest received from the mobile app.

9. The method according to claim 5, wherein, after the information of the image of the product of interest is matched to a product in the catalogue, the advertisement content is provided to the electronic device of the consumer concerning the brand or product.

10. The method according to claim 1, further comprising the step of creating the catalogue including receiving uploads of images of products and storing the images of products in the catalogue.

11. The method according to claim 10, wherein for each product in the catalogue, images include views from the front, rear, sides and top.

12. The method according to claim 1, further comprising the step of receiving via upload the advertisement content concerning the brand or product on a remote server.

13. The method according to claim 1, wherein the advertisement content includes at least one of a video, audio, an image, and text.

14. The method according to claim 1, wherein the advertisement content includes a coupon, rebate, or gamification.

15. The method according to claim 1, further comprising the steps of creating an advertisement campaign for at least one product and storing the advertisement campaign on a remote server, and associating the advertisement campaign with a brand, a brand owner, and a retail store.

16. The method according to claim 1, further comprising the step of tracking the number of views of the advertisement campaign during a predefined period of time.

17. The method according to claim 16, further comprising the step of automatically generating an invoice to the brand owner based on the number of views of the advertisement campaign during the predefined period of time.

18. The method according to claim 1, further comprising the step of providing a consumer rewards program by tracking the number of products viewed by each consumer within a set time period and issuing a reward to a consumer having viewed the largest number of products within the set time period.

19. The method according to claim 2, wherein the mobile app includes a call button that provides a direct consumer to retail store staff communication interface.

20. The method according to claim 19, further comprising the step of facilitating the direct consumer to retail store staff communication interface via the use of text or email messaging via the mobile app.
